(19) United States
(12) Patent Application Publication
(10) Pub. No.: US 2023/0383164 A1
(43) Pub. Date: Nov. 30, 2023

(54) METHODS OF MAKING AND USING A LUBRICANT COMPOSITION

(71) Applicant: Halliburton Energy Services, Inc., Houston, TX (US)

(72) Inventors: Sharad Bhimrao Gotmukle, Pune (IN); Nivika Rajendra Gupta, Pune (IN); Sudarshana Mukherjee, Pune (IN); Jay Deville, Houston, TX (US)

(21) Appl. No.: 17/751,831

(22) Filed: May 24, 2022

(51) Int. Cl. C09K 8/20; E21B 21/00

(52) U.S. Cl. CPC C09K 8/206; E21B 21/00; C09K 2208/34

(57) ABSTRACT

A lubricant composition, comprising (i) a vegetable oil; (ii) a surfactant; and (iii) a lime soap dispersing agent, wherein a mixture of the lubricant composition and a brine forms less than about 1 wt. % insoluble particulates based on a total weight of the mixture. A wellbore servicing fluid comprising (i) a lubricant composition comprising (a) a vegetable oil; (b) a surfactant; and (c) a lime soap dispersing agent; and (ii) a drilling mud comprising a base fluid wherein the base fluid comprises a brine. A method of servicing a wellbore comprising placing into a wellbore disposed in a subterranean formation a wellbore servicing fluid comprising a lubricant composition comprising (a) a vegetable oil; (b) a surfactant; and (c) a lime soap dispersing agent; a base fluid; and (iv) a brine.

### FIELD

This application relates to a composition, and more specifically this application relates to a lubricant composition for use in wellbore servicing fluids comprising monovalent or divalent brines.

### BACKGROUND

Hydrocarbons, such as oil and gas, residing in a subterranean formation or zone are usually recovered by drilling a wellbore down to the subterranean formation while circulating a drilling fluid in the wellbore. The drilling fluid is usually circulated downward through the interior of the drill pipe and upward through the annulus, which is located between the exterior of the drill pipe and the interior wall of the wellbore. For example, drilling fluids or muds are commonly circulated in the well during such drilling to cool and lubricate the drilling apparatus, lift cuttings out of the wellbore, and counterbalance the subterranean formation pressure encountered.

An important function of drilling fluid is to reduce the considerable torque on the rotating drill stem caused by the friction between the outside of the drill pipe comprising the drill stem and the wall of the well and/or casing strings. Drilling through offsets and highly deviated or horizontal wells results in increased frictional forces, increasing the demand on the lubricating properties of the drilling fluids. If the lubricating properties of the drilling fluids are not sufficient and the drill pipe encounters excessive torque, drilling may be interrupted by costly delays. Increased lubricity is also often desired during wellbore cleanup, coil tubing operations, wireline operations, and the running of production tubulars.

For several decades, brines have been utilized for well drilling and completions. High density brines have been found to have particular applicability for use in deep wells. While high density brines have been found sufficient in providing the lubricity and viscosity of a wellbore servicing fluid under extreme shear, pressure and temperature variances, such brines may prove ineffective if unable to exhibit the constant lubricity required during high shear conditions.

Therefore, an ongoing need exists for a lubricant composition able to maintain constant lubricity in a wellbore servicing fluid under a variety of conditions.

### SUMMARY

Disclosed herein is a lubricant composition, comprising (i) a vegetable oil; (ii) a surfactant; and (iii) a lime soap dispersing agent, wherein a mixture of the lubricant composition and a brine forms less than about 1 wt. % insoluble particulates based on a total weight of the mixture.

Also disclosed herein is a wellbore servicing fluid comprising (i) a lubricant composition comprising (a) a vegetable oil; (b) a surfactant; and (c) a lime soap dispersing agent; and (ii) a drilling mud comprising a base fluid wherein the base fluid comprises a brine.

Also disclosed herein is a method of servicing a wellbore comprising placing into a wellbore disposed in a subterranean formation a wellbore servicing fluid comprising a lubricant composition comprising (a) a vegetable oil; (b) a surfactant; and (c) a lime soap dispersing agent; a base fluid; and (iv) a brine.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 depicts a schematic embodiment of a wellbore servicing environment.

FIGS. 2A and 2B depict the results of cheese and grease tests for the indicated samples.

FIGS. 3-6 are graphs of the coefficient of friction as a function of reference loads for the indicated samples.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is to be understood that “subterranean formation” encompasses both areas below exposed earth and areas below earth covered by water such as ocean or fresh water. Herein in the disclosure, “top” means the well at the surface (e.g., at the wellhead which may be located on dry land or below water, e.g., a subsea wellhead), and the direction along a wellbore towards the well surface is referred to as “up”; “bottom” means the end of the wellbore away from the surface, and the direction along a wellbore away from the wellbore surface is referred to as “down.” For example, in a horizontal wellbore, two locations may be at the same level (i.e., depth within a subterranean formation), the location closer to the well surface (by comparing the lengths along the wellbore from the wellbore surface to the locations) is referred to as “above” the other location, the location farther away from the well surface (by comparing the lengths along the wellbore from the wellbore surface to the locations) is referred to as “below” or “lower than” the other location.

This disclosure relates generally to methods of making a lubricant composition which may be included in a wellbore servicing fluid. The wellbore servicing fluid including the lubricant composition may be introduced to a wellbore penetrating a subterranean formation. The methods disclosed herein involves making and using this lubricant composition for servicing a wellbore penetrating a subterranean formation, more specifically, for using this lubricant composition in a wellbore servicing fluid (WSF) to provide consistent lubricity during a drilling operation.

Herein the lubricant composition functions as an additive for lowering torque (rotary friction) and drag (axial friction) in the wellbore and to lubricate bit bearings if not sealed. In one or more specific embodiments, the lubricant composition includes a vegetable oil, a surfactant and a lime soap dispersing agent. Lubricant compositions of the type disclosed herein may be characterized by the maintenance of lubricity in the presence of monovalent or divalent brines. In particular, lubricant compositions of the type disclosed herein when contacted with monovalent or multivalent salts remain stable where stability refers to minimal or no detectable phase separation and/or the formation of insoluble particles or coagulation.

For example, a mixture of lubricant compositions of the type disclosed herein and a brine forms less than about 1 wt. % insoluble particles, alternatively less than about 0.5 wt. % insoluble particles or alternatively less than about 0.1 wt. % insoluble particles based on the total weight of the mixture. Hereinafter, the weight percent refers to the weight percent on the basis of the total weight of the composition being described. In another embodiment, a mixture of a lubricant composition of the type disclosed herein and a brine results no separation of the oil present in the mixture from the aqueous portion of the mixture. Alternatively, the volume ratio of the oil phase to aqueous phase is equal to or less than about 5:95, alternatively equal to or less than about 2:98 or alternatively equal to or less than about 1:99. In another embodiment, a mixture of a lubricant composition of the type disclosed herein and a brine results in no separation of the oil present in the mixture from the aqueous portion of the mixture. Alternatively, the volume ratio of the aqueous phase to oil phase is equal to or less than about 5:95, alternatively equal to or less than about 2:98 or alternatively equal to or less than about 1:99. Hereinafter, the lubricant compositions of this disclosure are termed pan-valent lubricant compositions, referring to their ability to provide lubricity in both monovalent and polyvalent salts, and designated PVLC.

In embodiments, the PVLC includes a vegetable oil. Any vegetable oil compatible with the other components of the PVLC may be included in the composition. Nonlimiting examples of vegetable oils that may be included in the PVLC are custard seed oil, almond oil, babassu oil, castor oil, clark A oil, avocado oil, apricot oil, coffee bean oil, coconut oil, corn oil, cotton seed oil, jojoba oil, mustard seed oil, olive oil, palm oil, peanut oil, safflower oil, sesame oil, soybean oil, sunflower seed oil, wheat germ oil rapeseed oil, meadowfoam oil, lesquerella oil, borage oil, evening primrose oil, palm kernel oil, canola oil, linseed oil, rice oil, or a combination thereof. In certain embodiments, the vegetable oil may include at least one fatty acid that includes from about 6 to about 22 carbon atoms. In such embodiments, the vegetable oil may include at least one of ricinoleic acid, oleic acid, linoleic acid, linolenic acid, stearic acid, palmitic acid, dihydroxystearic acid, octanoic acid, nonaoic acid, decanoic acid, lauric acid, myristic acid, and tricanoic acid, or a combination thereof. In certain embodiments, various other fatty acids and/or impurities may be present in the vegetable oil, as long as they do not unacceptably affect the lubricating effectiveness of the lubricant. In specific embodiments, the vegetable oil includes castor oil. Fatty acids of the type disclosed herein may be present in the vegetable oil in an amount of from about 0.1 wt. % to about 95 wt. %, alternatively from about 0.1 wt. % to about 6 wt. %, alternatively from about 10 wt. % to about 60 wt. % or alternatively from about 80 wt. % to about 95 wt. % based on the total weight of the vegetable oil.

In some embodiments, the PVLC may include vegetable oil in an amount of from about 30 weight percent (wt. %) to about 90 wt. %, alternatively from about 40 wt. % to about 90 wt. %, alternatively from about 30 wt. % to about 80 wt. %, alternatively from about 40 wt. % to about 80 wt. %, alternatively from about 50 wt. % to about 80 wt. %, alternatively from about 30 wt. % to about 50 wt. %, or alternatively from about 40 wt. % to about 70 wt. % based on the total weight of the PVLC. In some embodiments, the PVLC may include greater than or equal to about 30, 35, 40, 45, 50, 55, 60, 65, 70, 75, 80, 85, or 90 wt. % of the vegetable oil. In certain embodiments, the PVLC include about 70 wt. % vegetable oil. In certain embodiments, the PVLC may include about 40 wt. % vegetable oil.

In certain embodiments, a PVLC of the present disclosure may include from about 30 wt. % to about 90 wt. %, from about 40 wt. % to about 90 wt. %, from about 30 wt. % to about 80 wt. %, from about 40 wt. % to about 80 wt. %, or from about 40 wt. % to about 70 wt. % castor oil. In some embodiments, the PVLC may include greater than or equal to about 30, 35, 40, 45, 50, 55, 60, 65, 70, 75, 80, 85, or 90 weight percent castor oil. In certain embodiments, the PVLC may include from about 50 wt. % to about 80 wt. % castor oil. In certain embodiments, the PVLC may include from about 30 wt. % to about 50 wt. % castor oil. In certain embodiments, the PVLC may include about 70 wt. % castor oil. In certain embodiments, the PVLC may include about 40 wt. % castor oil.

In embodiments, the PVLC includes a surfactant, alternatively a non-ionic surfactant. The PVLC of the present disclosure may include at least one surfactant. In some embodiments, the surfactant may be a non-ionic surfactant. In some embodiments, the PVLC may include at least two surfactants. In some embodiments, the PVLC may include a blend of at least two surfactants. In certain embodiments, the PVLC may include a blend of at least two nonionic surfactants. In an embodiment, the at least two surfactants includes two surfactants which are blended in a ratio of Surfactant 1:Surfactant 2 is about 1:1, alternatively about 1:4, or alternatively about 1:5. In some embodiments, the PVLC may include at least three surfactants. In some embodiments, the PVLC may include a blend of at least three surfactants. In certain embodiments, the PVLC may include a blend of at least three nonionic surfactants. In an embodiment, the at least three surfactants are three surfactants which are blended in a ratio of Surfactant 1:Surfactant 2:Surfactant 3 of about 1:2:2 alternatively about 1:4:4 or alternatively about 1:5:5.

In some embodiments, a hydrophilic-lipophilic balance (HLB) of the at least one surfactant may be suitable to form a stable phase when combined with the vegetable oil. As used herein, the term “stable phase” refers to a phase that shows minimal or no detectable phase separation and/or coagulation by visual inspection, within the limits of the application. The PVLC of the present disclosure may include an oil soluble surfactant with a low HLB (e.g., an HLB value in the range of from about 1 to about 10). In certain embodiments, the PVLC may include an oil insoluble surfactant with a higher HLB (e.g., an HLB value in the range of from about 10 to about 20). In some embodiments, in absence of a surfactant with a low HLB (e.g., an HLB value in the range of from about 1 to about 10), the oil insoluble surfactant may phase out from a bulk or continuous oil phase including the vegetable oil. In certain embodiments, the oil soluble surfactant and the oil insoluble surfactant may together form a reverse micellar system and stabilize the bulk phase including the vegetable oil (e.g., castor oil).

In certain embodiments, the stable phase is formed when the at least one surfactant (e.g., a non-ionic surfactant) provides an HLB value in the range of from about 1 to about 20, alternatively from about 2 to about 20, alternatively from about 4 to about 18, alternatively from about 4 to about 17, alternatively from about 4 to about 12, alternatively from about 4 to about 8, alternatively from about 10 to about 18, alternatively from about 12 to about 18, alternatively from about 13 to about 17, alternatively from about 12 to about 17, alternatively from about 12 to about 16, alternatively from about 13 to about 16, alternatively from about 12 to about 15, alternatively from about 13 to about 15, or alternatively from about 14 to about 15. In some embodiments, the vegetable oil may form a stable phase when the at least one surfactant provides an HLB of equal to or about 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, or 18. The at least one surfactant may be selected for an optimum surface activity to create a stable phase with the vegetable oil (e.g., castor oil). In certain embodiments, the at least one surfactant may provide an HLB that is within 1, 2, 3, 4, or 5 of the HLB value suitable to form a stable phase with the vegetable oil.

The PVLC of the present disclosure may include at least one non-ionic surfactant. Suitable non-ionic surfactants may include, but are not limited to, linear alcohol polyethylene oxide ethers, polyethylene glycol (PEG) esters of fatty acids, sorbitan esters, and/or polyethoxylated sorbitan esters, or a combination thereof. In some embodiments, the PVLC may include from about 0.5 wt. % to about 50 wt. %, from about 0.5 wt. % to about 40 wt. %, from about 0.5 wt. % to about 30 wt. %, or from about 0.5 wt. % to about 20 wt. % of at least one non-ionic surfactant based on the total weight of the PVLC. In certain embodiments, the PVLC includes less than or equal to about 50, 40, 30, 20, 10, 5, 1 or 0.5 wt. % of the at least one non-ionic surfactant.

In certain embodiments, the at least one non-ionic surfactant includes sorbitan esters, and/or derivatives thereof, including, but not limited to, sorbitan monolaurate, sorbitan monopalmitate, sorbitan monostearate, sorbitan monooleate, sorbitan sesquioleate, sorbitan trioleate, sorbitan isostearate, polyethoxylated sorbitan esters, and any combination thereof. In certain embodiments, the PVLC may include from about 0.5 wt. % to about 40 wt. % of at least one sorbitan ester, and/or derivatives thereof, from about 0.5 wt. % to about 30 wt. % of at least one sorbitan ester, and/or derivatives thereof, from about 0.5 wt. % to about 20 wt. % of at least one sorbitan ester, and/or derivatives thereof, from about 1 wt. % to about 25 wt. % of at least one sorbitan ester, and/or derivatives thereof, from about 1 wt. % to about 15 wt. % of at least one sorbitan ester, and/or derivatives thereof, from about 1 wt. % to about 30 wt. % of at least one sorbitan ester, and/or derivatives thereof, from about 1 wt. % to about 35 wt. % of at least one sorbitan ester, and/or derivatives thereof, or from about 20 wt. % to about 30 wt. % of at least one sorbitan ester, and/or derivatives thereof. In some embodiments, the PVLC may include about 0.5, 0.8, 1.0, 1.2, 1.4, 1.6, 1.8, 2.0, 2.2, 2.4, 2.6, 2.8, 3.0, 3.2, 3.4, 3.6, 3.8, 4, 5, 6, 7, 8, 9, 10, 12, 14, 16, 18, 20, 22, 24, 26, 28, 30, 32, 34, 36, 38, or 40 weight percent of at least one sorbitan ester, and/or derivatives thereof.

In certain embodiments, the PVLC may include a single sorbitan ester. In some embodiments, the PVLC may include sorbitan monooleate, [(2R)-2-[(2R,3R,4S)-3,4-dihydroxyoxolan-2-yl]-2-hydroxyethyl] (Z)-octadec-9-enoate, otherwise known as Span™ 80 (available from Croda Inc., Plainsboro, NJ). In embodiments, the PVLC may include at least one sorbitan ester having a molecular weight of less than about 1500, about 1250, about 1000, about 950, about 750, or about 500 Daltons (Da).

In certain embodiments, the at least one non-ionic surfactant includes sorbitan polyoxyethylene fatty acid esters, including, but not limited to: polyethylene glycol sorbitan monolaurate, polyethylene glycol sorbitan monopalmitate, polyethylene glycol sorbitan monostearate, polyethylene glycol sorbitan tristearate, polyethylene glycol sorbitan monooleate, and any combination thereof. In some embodiments, the non-ionic surfactant may include a sorbitan ester that is polyethoxylated sorbitan monolaurate, polyethoxylated sorbitan monooleate, or a combination thereof. In some embodiments, the non-ionic surfactant may include at least one polyethoxylated sorbitan ester including from about 4 to about 20 moles of ethylene oxide, alternatively from about 10 to about 20 moles of ethylene oxide, or alternatively from about 10 to about 15 moles of ethylene oxide. In some embodiments, the non-ionic surfactant may include at least one polyethoxylated sorbitan ester including equal to or about 20 moles of ethylene oxide. For example, suitable non-ionic surfactants may include, without limitation, PEG-20 sorbitan monolaurate, PEG-20 sorbitan monopalmitate, PEG-20 sorbitan monostearate, PEG-20 sorbitan tristearate, and PEG-20 sorbitan monooleate.

In some embodiments, the PVLC according to the present disclosure may include a total weight percentage of at least one polyethoxylated sorbitan ester in a range of from about 5 wt. % to about 40 wt. %, from about 5 wt. % to about 30 wt. %, from about 10 wt. % to about 30 wt. %, or from about 15 wt. % to about 30 wt. % polyethoxylated sorbitan ester. In some embodiments, the PVLC may include a total weight percentage of at least one polyethoxylated sorbitan ester equal to or about 10, 11, 12, 13, 14, 15, 16, 17, 18, 19, 20, 21, 22, 23, 24, 25, 26, 27, 28, 29, 30, 31, 32, 33, 34, or 35 weight percent. In certain embodiments, the PVLC may include one polyethoxylated sorbitan ester. In certain embodiments, the PVLC may include two polyethoxylated sorbitan esters. In certain embodiments, the PVLC may include three or more polyethoxylated sorbitan esters. In some embodiments, the PVLC may include from about 2 wt. % to about 30 wt. %, from about 5 wt. % to about 25 wt. %, or from about 2 wt. % to about 10 wt. % of each of one or more polyethoxylated sorbitan esters based on the total weight of the PVLC.

In some embodiments, the at least one non-ionic surfactant includes sorbitan monooleate (e.g., Span™ 80 (Croda Inc., Plainsboro, NJ)), polyethoxylated sorbitan monooleate (e.g., Tween® (Croda Americas L.L.C., Switzerland), polyethoxylated sorbitan monolaurate (e.g., Tween® 20 (Croda Americas L.L.C., Switzerland), or any combination thereof. In certain embodiments, the PVLC may include from about 2 wt. % to about 5 wt. % of sorbitan monooleate, from about 5 wt. % to about 12 wt. % polyethoxylated sorbitan monooleate and from about 8 wt. % to about 13 wt. % polyethoxylated sorbitan monolaurate. In certain embodiments, the PVLC may include about 2 wt. % of sorbitan monooleate, about 8 wt. % polyethoxylated sorbitan monooleate and about 9 wt. % polyethoxylated sorbitan monolaurate. In some embodiments, the PVLC may include from about 15 wt. % to about 30 wt. % of sorbitan monooleate and from about 4 wt. % to about 8 wt. % polyethoxylated sorbitan monolaurate. In some embodiments, the PVLC may include about 24 wt. % sorbitan monooleate and about 6 wt. % polyethoxylated sorbitan monolaurate.

In one or more embodiments, the PVLC includes a lime soap dispersing agent. Herein lime soap refers generally to insoluble calcium salts of fatty acids which are in the form of large aggregates of about 0.01 cm to 0.03 cm or 100 microns to 300 microns in size. The lime soap dispersing agent can be used as a dispersing agent which refers a substance added to a suspension of solid or liquid particles in a liquid (such as a colloid or emulsion) to improve the dispersion f the test fluid and to prevent clumping or agglomeration.

In specific embodiments, the lime soap dispersing agent includes a compound characterized by the presence of ether carboxylate moieties. For example, a lime soap dispersing agent may be characterized by the general formula R—O—(R′O—)ₙCH₂COOX where R is an alkyl group containing from about 5 to about 23 carbon atoms and R′ is an alkyl group containing from about 1 to about 22 carbon atoms, X is a H, Na, Br, Cl, or K and ‘n’ ranges from about 2 to about 10. The alkyl groups of R and R′ may independently be saturated, unsaturated, linear, branched or a combination thereof.

In other embodiments, the lime soap dispersing agent includes a compound having the general formula RO(CH₂CHO)ₙCOOH where n is a positive integer such that 1≤n≤8 and R is any hydrocarbon group having from about 1 to about 30 carbon atoms.

In other embodiments, the lime soap dispersing agent includes one or more oleophilic fatty acid salts such as those based on amido amines of the general formula NZ₃ wherein N is nitrogen and Z represents RCONH(CH₂)₂ where R is a C₈ to C₂₄ hydrocarbon chain. In other embodiments, the lime soap dispersing agent is characterized by the general formula NHZX where N is nitrogen, H is hydrogen, Z represents RCONH(CH₂)₂ where R is a C₈ to C₂₄ hydrocarbon chain and X is, a carboxylate for example, ethoxylate.

In specific embodiments, the lime soap dispersing agent includes a carboxylic acid ether such as and without limitation glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or a combination thereof.

The lime soap dispersing agent may be present in the PVLC in an amount of from about 0.1 wt. % to about 10 wt. %, alternatively from about 2 wt. % to about 4 wt. % or alternatively from about 5 wt. % to about 10 wt. % based on the total weight of the PVLC.

A PVLC of the present disclosure may be stable at high temperatures (e.g., capable of maintaining lubricity at least up to 250° F. (121.1° C.), or at least up to 300° F. (148.9° C.)). The PVLC may exhibit stability e.g., exhibiting no or reduced precipitation and/or color change, at temperatures of from about 40° F. (4.4° C.) to about 120° F. (48.9° C.), alternatively from about 0° F. (−17.8° C.) to about 120° F. (48.9° C.), alternatively from about 0° F. (−17.8° C.) to about 140° F. (60.0° C.), or alternatively from about 0° F. (−17.8° C.) to about 160° F. (71.1° C.).

In one or more embodiments, a composition of the present disclosure includes a PVLC and a brine in weight percent of about 0.5% PVLC and about 99.5% brine, alternatively about 1% PVLC and about 99% brine, alternatively about 5% PVLC and about 95% brine or alternatively about 10% PVLC and 90% brine.

The PVLC of the present disclosure may be provided in a wellbore servicing fluid. The wellbore servicing fluid of the present disclosure may include any suitable base fluid, including an aqueous fluid, a non-aqueous fluid, an aqueous-miscible fluid, or any combination thereof. As used herein, the term “base fluid” refers to the major component of the fluid (as opposed to components dissolved and/or suspended therein), and does not indicate any particular condition or property of that fluid such as its mass, amount, pH, etc. Suitable base fluids into which the PVLC may be incorporated may include aqueous-based fluid systems, such as brines, water-based muds, and invert emulsion fluid systems, such as water-in-oil emulsions and oil-in-water emulsions.

Aqueous base fluids that may be suitable for use in the methods and compositions of the present disclosure may include water from any source. Such aqueous base fluids may include fresh water, salt water (e.g., water containing one or more salts dissolved therein), brine (e.g., saturated salt water), seawater, and/or any combination thereof. The aqueous base fluids may be from a source that does not contain compounds that adversely affect other components of a fluid. In certain embodiments of the present disclosure, the aqueous base fluids may include one or more ionic species, such as those formed by salts dissolved in water. For example, seawater and/or produced water may include a variety of divalent cationic species dissolved therein.

In certain embodiments, an aqueous base fluid according to the present disclosure may include water with one or more water-soluble salts dissolved therein. In certain embodiments, the one or more salts may include inorganic salts, formate salts, or any combination thereof. Inorganic salts may include monovalent salts, which may be further include alkali metal halides (e.g., sodium chloride), ammonium halides, and any combination thereof. Brines including such monovalent salts may be referred to as “monovalent brines.” Inorganic salts may also include divalent salts, such as alkaline earth metal halides (e.g., CaCl₂), CaBr₂, etc.) and zinc halides. Brines including such divalent salts may be referred to as “divalent brines.” Brines including halide-based salts may be referred to as “halide-based brines.”

In some embodiments, the aqueous base fluid may include a monovalent brine, a divalent brine, or a combination thereof. Suitable monovalent brines may include, but are not limited to, sodium chloride brines, sodium bromide brines, potassium chloride brines, and potassium bromide brines. Suitable divalent brines may include, but are not limited to, magnesium chloride brines, calcium chloride brines, and calcium bromide brines.

Monovalent salts may be used to prepare wellbore servicing fluids, and may have an aqueous phase having a density up to about 12.5 lb/gal (1498 kg/m³). Divalent salts and formate salts may be used to form drilling or wellbore fluids having an aqueous phase having a density up to about 19.2 lb/gal (2300 kg/m³). In some embodiments, the one or more inorganic salts may be in a sufficient concentration such that the density of the aqueous phase is in the range of about 9 lb/gal (1078 kg/m³) to about 19.2 lb/gal (2300 kg/m³). In some embodiments according to the present disclosure, the one or more inorganic salts may be selected and in a sufficient concentration such that the density of the aqueous phase is greater than about 9.5 lb/gal (1138 kg/m³). In some embodiments according to the present disclosure, the one or more inorganic salts are selected and in a sufficient concentration such that the density of the aqueous phase is greater than about 13 lb/gal (1558 kg/m³).

In some embodiments, a wellbore servicing fluid of the present disclosure may include a brine having a density in the range of from about 9 to about 12.5 lbs/gal (pounds per gallon or “ppg”) (from about 1078 to about 1498 kg/m³), from about 9.5 to about 12.5 ppg (from about 1138 to about 1498 kg/m³), or from about 9 to about 12 ppg (from about 1078 to about 1438 kg/m³). In some embodiments, a wellbore servicing fluid of this disclosure may include a brine having a density of greater than or equal to about 9, 9.5, 10, 10.5, 11, or 11.5 ppg (greater than or equal to about 1078, 1138, 1198, 1258, 1318, or 1378 kg/m³).

Examples of a non-aqueous base fluid that may be suitable for use as a carrier fluid include, but are not limited to an oil or oleaginous fluid, a hydrocarbon, an organic liquid, a mineral oil, a synthetic oil, an ester, or any combination thereof. Examples of non-aqueous base fluids suitable for certain embodiments of the present disclosure include, but are not limited to, natural oil based muds (OBM), synthetic based muds (SBM), natural base oils, synthetic base oils and invert emulsions. In certain embodiments, the non-aqueous base fluid may include safra oil. In certain embodiments, the non-aqueous base fluid may include any petroleum oil, natural oil, synthetically derived oil, or combinations thereof. In some embodiments, OBMs and SBMs may include some non-oleaginous fluid such as water, making them water-in-oil type emulsions, also known as invert emulsions wherein a non-oleaginous fluid (e.g. water) includes the internal phase and an oleaginous fluid includes the external phase. The non-oleaginous fluid (e.g. water) may arise in the wellbore servicing fluid itself or from the wellbore, or it may be intentionally added to affect the properties of the wellbore servicing fluid. Any known non-aqueous fluid may be used to form the external oil phase of the invert emulsion fluid. In certain embodiments, the non-aqueous base fluid does not include a significant amount of water.

Suitable water-in-oil emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. It should be noted that for water-in-oil and oil-in-water emulsions, any mixture of the above may be used including the water being and/or including an aqueous-miscible fluid. In certain embodiments, when a PVLC of the present disclosure is added to an aqueous base fluid, the vegetable oil may form an oil-in-water emulsion as a result of a surfactant with a higher HLB (e.g., an HLB value in the range of from about 10 to about 20) present in the PVLC.

Suitable aqueous-miscible fluids may include, but are not limited to, alcohols (e.g., methanol, ethanol, n-propanol, isopropanol, n-butanol, sec-butanol, isobutanol, and t-butanol; glycerins); glycols (e.g., polyglycols, propylene glycol, and ethylene glycol); polyglycol amines; polyols; any derivative thereof; any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate); any of the above in combination with an aqueous fluid; and any combination thereof.

In certain embodiments, the density of the base fluid may be adjusted, among other purposes, to provide additional particulate transport and suspension in the compositions of the present disclosure. In certain embodiments, the pH of the base fluid may be adjusted (e.g., by a buffer or other pH adjusting agent) to a specific level, which may depend on, among other factors, the types of PVLC, and/or other additives included in the fluid. One of ordinary skill in the art, with the benefit of this disclosure, will recognize when such density and/or pH adjustments are appropriate. In certain embodiments, the wellbore servicing fluids may include a mixture of one or more fluids and/or gases, including but not limited to emulsions and foams.

The PVLC used in accordance with the methods and compositions of the present disclosure may be present in the wellbore servicing fluid in an amount sufficient to provide a desired lubricity. In certain embodiments, the PVLC may be present in the wellbore servicing fluid in an amount from about 0.1 wt. % to about 20 wt. % or alternatively from about 1 wt. % to about 20 wt. %. In certain embodiments, the PVLC may be present in the wellbore servicing fluid in an amount from about 0.1 wt. % to about 10 wt. % by total weight of the wellbore servicing fluid. In certain embodiments, the PVLC may be present in the wellbore servicing fluid in an amount from about 0.5 wt. % to about 5 wt. % by total weight of wellbore servicing the fluid. In certain embodiments, the PVLC may be present in the wellbore servicing fluid in an amount of about 2 wt. % by total weight of the wellbore servicing fluid. In some embodiments, the PVLC may be present in the wellbore servicing fluid in an amount from about 0.5 wt. % to about 1.5 wt. %, in other embodiments, from about 1.5 wt. % to about 2.5 wt. %, in other embodiments, from about 2.5 wt. % to about 3.5 wt. %, in other embodiments, from about 3.5 wt. % to about 4.5 wt. %, and in other embodiments, from about 4.5 wt. % to about 5.5 wt. % based on the total weight of the wellbore servicing fluid.

In certain embodiments, the wellbore servicing fluids used in accordance with the methods of the present disclosure optionally may include a weighting agent. In some embodiments, the weighting agent may be added to produce a desired density in the wellbore servicing fluid. In certain embodiments, the weighting agent may include barite. Examples of other weighting agents include, but are not limited to, hematite, magnetite, iron oxides, illmenite, siderite, celestite, dolomite, olivine, calcite, magnesium oxides, halites, calcium carbonate, strontium sulfate, and manganese tetraoxide.

In certain embodiments, the wellbore servicing fluids including a PVLC optionally may include one or more additional surfactants. The additional surfactant may, among other purposes, help disperse the PVLC and/or other additives in a wellbore servicing fluid. Examples of additional surfactants that may be suitable for use may include, but are not limited to, an alkoxylated alkyl alcohol and salts thereof, an alkoxylated alkyl phenol and salts thereof, an alkyl or aryl sulfonate, a sulfate, a phosphate, a carboxylate, a polyoxyalkyl glycol, a fatty alcohol, a polyoxyethylene glycol sorbitan alkyl ester, a sorbitan alkyl ester, a polysorbate, a glucoside, a quaternary amine compound, an amine oxide surfactant, or any combination thereof.

In certain embodiments, the wellbore servicing fluids used in accordance with the methods of the present disclosure optionally may include any number of additional additives. Examples of such additional additives include, but are not limited to, salts, additional surfactants, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, shale inhibitors, biocides, additional friction reducers, antifoam agents, bridging agents, flocculants, H₂S scavengers, CO₂ scavengers, oxygen scavengers, lost circulation materials, additional lubricants, additional viscosifiers, breakers, weighting agents, relative permeability modifiers, resins, wetting agents, coating enhancement agents, filter cake removal agents, and antifreeze agents (e.g., ethylene glycol or polyethylene glycol). Such additives may be included in the wellbore servicing fluid singularly or in combination. In embodiments, the one or more additives are present in the wellbore servicing fluid in an amount of from about 0.001 wt. % to about 50 wt. %, based on the total weight of the wellbore servicing fluid, alternatively from about 0.1 wt. % to about 50 wt. %, or alternatively from about 1 wt. % to about 40 wt. %.

The wellbore servicing fluids of the present disclosure may be prepared using any suitable method and/or equipment (e.g., blenders, mixers, stirrers, etc.) known in the art at any time prior to their use. The wellbore servicing fluids may be prepared at a well site or at an offsite location.

The present disclosure in some embodiments provides methods for using the wellbore servicing fluids to carry out a variety of subterranean treatments or operations, including but not limited to, drilling operations, cementing operations, fracturing operations, gravel packing operations, workover operations, and the like. In some embodiments, the wellbore servicing fluids of the present disclosure may be drilling fluids used for drilling a wellbore into a subterranean formation.

In certain embodiments, a wellbore servicing fluid including a PVLC may be introduced into a subterranean formation. In certain embodiments, the subterranean formation may have a bottom hole temperature of from about 66° C. (150° F.) to about 204° C. (400° F.). In certain embodiments, the subterranean formation may have a bottom hole temperature of from about 93° C. (200° F.) to about 204° C. (400° F.). In certain embodiments, the subterranean formation may have a bottom hole temperature of from about 93° C. (200° F.) to about 177° C. (350° F.). In certain embodiments, the subterranean formation may have a bottom hole temperature of at least 177° C. (350° F.). In some embodiments, the wellbore servicing fluid including the PVLC may be used to drill at least a portion of a wellbore in the subterranean formation. In some embodiments, the wellbore servicing fluid may circulate through the wellbore while drilling into the subterranean formation. In some embodiments, the wellbore servicing fluid including the PVLC may be introduced into a wellbore that penetrates a subterranean formation.

In some embodiments, the methods of the present disclosure may include foaming the wellbore servicing fluid by incorporating air, nitrogen, an appropriate foamer, glass spheres, or any combination thereof into the fluid. In certain embodiments, the wellbore servicing fluid may be introduced into the wellbore using one or more pumps. In some embodiments, the PVLC, wellbore servicing fluids, and/or additional additives may be used in treating a portion of a subterranean formation, for example, in acidizing treatments such as matrix acidizing or fracture acidizing. In some embodiments, the wellbore servicing fluid including the PVLC may be introduced at a pressure sufficient to create or enhance one or more fractures within the subterranean formation (e.g., hydraulic fracturing).

In certain embodiment, the wellbore servicing fluids of the present disclosure may be introduced into a subterranean formation, a wellbore penetrating a subterranean formation, tubing (e.g., pipeline), and/or a container using any suitable method or equipment. Introduction of the wellbore servicing fluids of the present disclosure may in such embodiments include delivery via any of a tube, umbilical, pump, gravity, and combinations thereof. The wellbore servicing fluids of the present disclosure may, in various embodiments, be delivered downhole (e.g., into the wellbore) or into top-side flowlines/pipelines or surface treating equipment.

For example, in certain embodiments, the PVLC, wellbore servicing fluids, and/or additional additives of the present disclosure may be introduced into a subterranean formation and/or wellbore using batch treatments, squeeze treatments, continuous treatments, and/or combinations thereof. In certain embodiments, a batch treatment may be performed in a subterranean formation by stopping production from the well and pumping a certain amount of the PVLC, wellbore servicing fluids, and/or additional additives into a wellbore, which may be performed at one or more points in time during the life of a well. In other embodiments, a squeeze treatment may be performed by dissolving the PVLC, wellbore servicing fluids, and/or additional additives in a suitable solvent at a suitable concentration and squeezing that solvent carrying the PVLC or additional additives downhole into the formation, allowing production out of the formation to bring the PVLC and/or additional additives to the desired location.

In some embodiments, the present disclosure provides methods and compositions for using the PVLC, wellbore servicing fluids, and/or additional additives to carry out a variety of subterranean treatments, including but not limited to, preflush treatments, afterflush treatments, hydraulic fracturing treatments, acidizing treatments, sand control treatments (e.g., gravel packing), “frac-pack” treatments, wellbore clean-out treatments, drilling operations, and other operations where a wellbore servicing fluid may be useful. Such wellbore servicing fluids may include, but are not limited to, drilling fluids, preflush fluids, afterflush fluids, fracturing fluids, acidizing fluids, gravel packing fluids, packer fluids, spacer fluids, and the like.

In the methods and compositions of the present disclosure, the PVLC may be added to, or included in, a wellbore servicing fluid in any amount that may effectively increase the lubricity of a fluid to be treated to meet some user and/or process goal. In certain embodiments, an initial amount of PVLC may be added to a wellbore servicing fluid followed by subsequent, additional amounts. This technique may be used to increase and/or maintain a concentration of PVLC that may be sufficient to maintain a desired lubricity in a fluid to be treated throughout the course of a given operation.

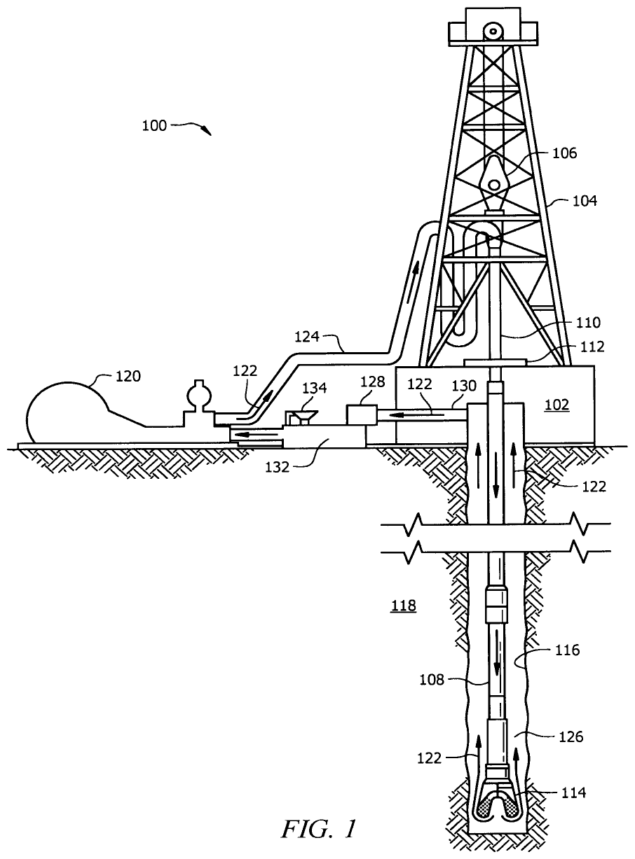

The wellbore servicing fluids of the present disclosure may directly or indirectly affect one or more components or pieces of equipment associated with the preparation, delivery, recapture, recycling, reuse, and/or disposal of the disclosed wellbore servicing fluids. For example, and with reference to FIG. 1, the disclosed wellbore servicing fluids may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed wellbore servicing fluids including a PVLC may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed wellbore servicing fluids may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed wellbore servicing fluids may be stored, reconditioned, and/or regulated until added to the drilling fluid 122.

As mentioned above, the disclosed wellbore servicing fluids may directly or indirectly affect the components and equipment of the drilling assembly 100. For example, the disclosed wellbore servicing fluids may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, and any fluid reclamation equipment. The fluid processing unit(s) 128 may further include one or more sensors, gauges, pumps, compressors, and the like used store, monitor, regulate, and/or recondition the exemplary wellbore servicing fluids.

The disclosed wellbore servicing fluids may directly or indirectly affect the pump 120, which representatively includes any conduits, pipelines, trucks, tubulars, and/or pipes used to fluidically convey the wellbore servicing fluids downhole, any pumps, compressors, or motors (e.g., topside or downhole) used to drive the wellbore servicing fluids into motion, any valves or related joints used to regulate the pressure or flow rate of the wellbore servicing fluids, and any sensors (i.e., pressure, temperature, flow rate, etc.), gauges, and/or combinations thereof, and the like. The disclosed wellbore servicing fluids may also directly or indirectly affect the mixing hopper 134 and the retention pit 132 and their assorted variations.

The disclosed wellbore servicing fluids may also directly or indirectly affect the various downhole equipment and tools that may come into contact with the wellbore servicing fluids such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed wellbore servicing fluids may also directly or indirectly affect any downhole heat exchangers, valves and corresponding actuation devices, tool seals, packers and other wellbore isolation devices or components, and the like associated with the wellbore 116. The disclosed wellbore servicing fluids may also directly or indirectly affect the drill bit 114, which may include, but is not limited to, roller cone bits, PDC bits, natural diamond bits, any hole openers, reamers, coring bits, etc.

While not specifically illustrated herein, the disclosed wellbore servicing fluids may also directly or indirectly affect any transport or delivery equipment used to convey the wellbore servicing fluids to the drilling assembly 100 such as, for example, any conduits, pipelines, trucks, tubulars, and/or pipes used to fluidically move the wellbore servicing fluids from one location to another, any pumps, compressors, or motors used to drive the wellbore servicing fluids into motion, any valves or related joints used to regulate the pressure or flow rate of the wellbore servicing fluids, and any sensors (i.e., pressure and temperature), gauges, and/or combinations thereof, and the like.

An embodiment of the present disclosure is a method including introducing a wellbore servicing fluid that includes a base fluid and a PVLC including at least one vegetable oil, at least one nonionic surfactant and a lime soap dispersing agent into at least a portion of a subterranean formation.

Another embodiment of the present disclosure is a composition including a PVLC that includes at least one vegetable oil, at least one nonionic surfactant, and at least one a lime soap dispersing agent.

Another embodiment of the present disclosure is a method including introducing a wellbore servicing fluid that includes a divalent brine, a PVLC including at least one vegetable oil, at least one nonionic surfactant, and at least one a lime soap dispersing agent into at least a portion of a subterranean formation; and using the wellbore servicing fluid to drill at least a portion of a well bore penetrating at least a portion of the subterranean formation; wherein a coefficient of friction of the wellbore servicing fluid is lower than a fluid having a same composition as the wellbore servicing fluid but does not include the PVLC.

Another embodiment of the present disclosure is a method including introducing a wellbore servicing fluid that includes a base fluid, a PVLC including at least one vegetable oil, at least one nonionic surfactant, and at least one a lime soap dispersing agent into at least a portion of a subterranean formation, wherein a coefficient of friction of the wellbore servicing fluid is lower than that of a fluid having a same composition as the wellbore servicing fluid but does not include the PVLC. Optionally in this embodiment or any other embodiment disclosed herein, the base fluid includes at least one component selected from the group consisting of: an aqueous fluid, a non-aqueous fluid, an aqueous-miscible fluid, and any combination thereof. Optionally in this embodiment or any other embodiment disclosed herein, the base fluid includes at least one component selected from the group consisting of a monovalent brine, a divalent brine, and any combination thereof. Optionally in this embodiment or any other embodiment disclosed herein, the base fluid includes a divalent brine. Optionally in this embodiment or any other embodiment disclosed herein, the at least one vegetable oil includes castor oil. Optionally in this embodiment or any other embodiment disclosed herein, the at least one nonionic surfactant is selected from the group consisting of: sorbitan monooleate, polyethoxylated sorbitan monooleate, polyethoxylated sorbitan monolaurate, and any combination thereof. Optionally in this embodiment or any other embodiment disclosed herein, the at least one lime soap dispersing agent is selected from the group consisting of glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or one or more combinations thereof. Optionally in this embodiment or any other embodiment disclosed herein, the PVLC includes the at least one vegetable oil (e.g., castor oil) in an amount from about 30 wt. % to about 80 wt. % by total weight of the PVLC. Optionally in this embodiment or any other embodiment disclosed herein, the PVLC includes the at least one lime soap dispersing agent in an amount from about 0.1 wt. % to about 10 wt. % by total weight of the PVLC.

Another embodiment of the present disclosure is a composition including a PVLC that includes at least one vegetable oil, at least one nonionic surfactant, and at least one lime soap dispersing agent, wherein the composition is a drilling fluid that further includes a divalent brine. Optionally in this embodiment or any other embodiment disclosed herein, the at least one nonionic surfactant is selected from the group consisting of: sorbitan monooleate, polyethoxylated sorbitan monooleate, polyethoxylated sorbitan monolaurate, and any combination thereof. Optionally in this embodiment or any other embodiment disclosed herein, the at least one lime soap dispersing agent is selected from the group consisting of: glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or one or more combinations thereof. Optionally in this embodiment or any other embodiment disclosed herein, the at least one vegetable oil includes castor oil, the at least one nonionic surfactant includes sorbitan monooleate, polyethoxylated sorbitan monooleate and polyethoxylated sorbitan monolaurate, and the at least one lime soap dispersing agent includes a fatty acid ester. Optionally in this embodiment or any other embodiment disclosed herein, the at least one vegetable oil includes castor oil, the at least one nonionic surfactant includes sorbitan monooleate and polyethoxylated sorbitan monolaurate, and the at least one lime soap dispersing agent includes glycolic acid ethoxylate oleyl ether.

Another embodiment of the present disclosure is a method including introducing a wellbore servicing fluid that includes a divalent brine and a PVLC including at least one vegetable oil, at least one nonionic surfactant, and at least one lime soap dispersing agent into at least a portion of a subterranean formation; and using the wellbore servicing fluid to drill at least a portion of a well bore penetrating at least a portion of the subterranean formation; wherein a coefficient of friction of the wellbore servicing fluid is lower than a fluid having a same composition as the wellbore servicing fluid but does not include the PVLC, wherein the at least one vegetable oil includes castor oil. To facilitate a better understanding of the present disclosure, the following examples of certain aspects of certain embodiments are given. The following examples are not the only examples that could be given according to the present disclosure and are not intended to limit the scope of the disclosure or claims.

### ADDITIONAL DISCLOSURE

The following are non-limiting, specific aspects in accordance with the present disclosure:

A first aspect which is a lubricant composition, comprising (i) a vegetable oil; (ii) a surfactant; and (iii) a lime soap dispersing agent, wherein a mixture of the lubricant composition and a brine forms less than about 1 wt. % insoluble particulates based on a total weight of the mixture.

A second aspect which is the lubricant composition of the first aspect, wherein the vegetable oil comprises custard seed oil, almond oil, babassu oil, castor oil, clark A oil, avocado oil, apricot oil, coffee bean oil, coconut oil, corn oil, cotton seed oil, jojoba oil, mustard seed oil, olive oil, palm oil, peanut oil, safflower oil, sesame oil, soybean oil, sunflower seed oil, wheat germ oil rapeseed oil, meadowfoam oil, lesquerella oil, borage oil, evening primrose oil, palm kernel oil, canola oil, linseed oil, rice oil, or a combination thereof.

A third aspect which is the lubricant composition of any of the first through second aspects wherein the vegetable oil further comprises a fatty acid having from about 6 to about 22 carbon atoms.

A fourth aspect which is the lubricant composition of the third aspect wherein the fatty acid comprises ricinoleic acid, oleic acid, linoleic acid, linolenic acid, stearic acid, palmitic acid, dihydroxystearic acid, octanoic acid, nonaoic acid, decanoic acid, lauric acid, myristic acid, and tricanoic acid, or any combination thereof. ricinoleic acid, oleic acid, linoleic acid, linolenic acid, stearic acid, palmitic acid, dihydroxystearic acid, octanoic acid, nonaoic acid, decanoic acid, lauric acid, myristic acid, tricanoic acid, or a combination thereof.

A fifth aspect which is the lubricant composition of any of the first through fourth aspects wherein the vegetable oil is present in an amount of from about 30 wt. % to about 90 wt. % based on a total weight of the composition.

A sixth aspect which is the lubricant composition of any of the first through fifth aspects wherein the surfactant comprises a non-ionic surfactant.

A seventh aspect which is the lubricant composition of any of the first through sixth aspects wherein the surfactant comprises a blend of at least two non-ionic surfactants.

An eighth aspect which is the lubricant composition of any of the first through seventh aspects wherein the surfactant has a hydrophilic-lipophilic balance of from about 1 to about 10.

A ninth which is the lubricant composition of any of the first through eighth aspects wherein the surfactant has a hydrophilic-lipophilic balance of from about 10 to about 20.

A tenth aspect which is the lubricant composition of any of the first through ninth aspects wherein the surfactant comprises linear alcohol polyethylene oxide ethers, polyethylene glycol (PEG) esters of fatty acids, sorbitan esters, polyethoxylated sorbitan esters, sorbitan monolaurate, sorbitan monopalmitate, sorbitan monostearate, sorbitan monooleate, sorbitan sesquioleate, sorbitan trioleate, sorbitan isostearate, polyethylene glycol sorbitan monolaurate, polyethylene glycol sorbitan monopalmitate, polyethylene glycol sorbitan monostearate, polyethylene glycol sorbitan tristearate, polyethylene glycol sorbitan monooleate, or a combination thereof.

An eleventh aspect which is the lubricant composition of any of the first through tenth aspects wherein the surfactant is present in the lubricant composition in an amount of from about 0.5 wt. % to about 50 wt. % based on the total weight of the composition.

A twelfth aspect which is the lubricant composition of any of the first through eleventh aspects wherein the lime soap dispersing agent comprises a compound having a general formula may be characterized by the general formula R—O—(R′O—)ₙCH₂COOX where R is an alkyl group containing from about 5 to about 23 carbon atoms and R′ is an alkyl group containing from about 1 to about 22 carbon atoms, X is a H, Na, Br, Cl, or K and ‘n’ ranges from about 2 to about 10.

A thirteenth aspect which is the lubricant composition of the twelfth aspect wherein the alkyl group of R and R are each independently saturated, unsaturated, linear or branched.

A fourteenth aspect which is the lubricant composition of any of the first through thirteenth aspects, wherein the lime soap dispersing agent comprises one or more oleophilic fatty acid salts represented by the general formula NZ₃ wherein N is nitrogen, Z represents RCONH(CH₂)₂ and R is a C₈ to C₂₄ hydrocarbon chain.

A fifteenth aspect which is the lubricant composition of any of the first through fourteenth aspects, wherein the lime soap dispersing agent comprises one or more oleophilic fatty acid salts represented by the general formula NHZX where N is nitrogen, H is hydrogen, Z represents RCONH(CH₂)₂ where R is a C₈ to C₂₄ hydrocarbon chain and X is a carboxylate.

A sixteenth aspect which is the lubricant composition of any of the first through fifteenth aspects wherein the lime soap dispersing agent comprises glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or a combination thereof.

A seventeenth aspect which is the lubricant composition of any of the first through sixteenth aspects wherein the lime soap dispersing agent is present in an amount of from about 0.1 wt. % to about 10 wt. % based on the total weight of the composition.

An eighteenth aspect which is the lubricant composition of any of the first through seventeenth aspects having a temperature stability of equal to or greater than about 250° F. (121.1° C.).

A nineteenth aspect which is the lubricant composition of any of the first through eighteenth aspects having no phase separation when mixed with a divalent brine.

A twentieth aspect which is a wellbore servicing fluid comprising: (i) a lubricant composition comprising (a) a vegetable oil; (b) a surfactant; and (c) a lime soap dispersing agent; and (ii) a drilling mud comprising a base fluid wherein the base fluid comprises a brine.

A twenty-first aspect which is the wellbore servicing fluid of the twentieth aspect wherein the lubricant composition is present in an amount of from about 1 wt. % to about 20 wt. %.

A twenty-second aspect which is the wellbore servicing fluid of any of the twentieth through twenty-first aspects wherein the vegetable oil comprises custard seed oil, almond oil, babassu oil, castor oil, clark A oil, avocado oil, apricot oil, coffee bean oil, coconut oil, corn oil, cotton seed oil, jojoba oil, mustard seed oil, olive oil, palm oil, peanut oil, safflower oil, sesame oil, soybean oil, sunflower seed oil, wheat germ oil rapeseed oil, meadowfoam oil, lesquerella oil, borage oil, evening primrose oil, palm kernel oil, canola oil, linseed oil, rice oil, or a combination thereof.

A twenty-third aspect which is the wellbore servicing fluid of any of the twentieth through twenty-second aspects wherein the vegetable oil comprises castor oil.

A twenty-fourth aspect which is the wellbore servicing fluid of any of the twentieth through twenty-third aspects wherein the surfactant comprises linear alcohol polyethylene oxide ethers, polyethylene glycol (PEG) esters of fatty acids, sorbitan esters, polyethoxylated sorbitan esters, sorbitan monolaurate, sorbitan monopalmitate, sorbitan monostearate, sorbitan monooleate, sorbitan sesquioleate, sorbitan trioleate, sorbitan isostearate, polyethylene glycol sorbitan monolaurate, polyethylene glycol sorbitan monopalmitate, polyethylene glycol sorbitan monostearate, polyethylene glycol sorbitan tristearate, polyethylene glycol sorbitan monooleate, or a combination thereof.

A twenty-fifth aspect which is the wellbore servicing fluid of any of the twentieth through twenty-fourth aspects wherein the lime soap dispersing agent comprises glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or a combination thereof.

A twenty-sixth aspect which is the wellbore servicing fluid of any of twentieth through twenty-fifth aspects wherein the brine is monovalent, divalent or a combination thereof.

A twenty-seventh aspect which is the wellbore servicing fluid of any of the twentieth through twenty-sixth aspects wherein the wellbore servicing fluid has a density of from about 9 lbs/gal to about 12.5 lbs/gal.

A twenty-eight aspect which is the wellbore servicing fluid of any of the twentieth through twenty-seventh aspects, wherein the base fluid is nonaqueous.

A twenty-ninth aspect which is the wellbore servicing fluid of any of the twentieth through twenty-eighth aspects, wherein the base fluid comprises petroleum oil, synthetically-derived oil, natural oil based muds, synthetic-based muds, natural base oils, synthetic base oils, invert emulsions or a combination thereof.

A thirtieth aspect which is a method of servicing a wellbore comprising placing into a wellbore disposed in a subterranean formation a wellbore servicing fluid comprising a lubricant composition comprising (a) a vegetable oil; (b) a surfactant; and (c) a lime soap dispersing agent a base fluid; and a brine.

A thirty-first aspect which is the method of the thirtieth aspect, wherein the subterranean formation has a bottom hole temperature of from about 66° C. (150° F.) to about 204° C. (400° F.).

A thirty-second aspect which is the method of any of the thirtieth through thirty-first aspects wherein the vegetable oil comprises castor oil; the surfactant comprises a non-ionic surfactant and the lime soap dispersing agent comprises may be characterized by the general formula R—O—(R′O—)ₙCH₂COOX where R is an alkyl group containing from about 5 to about 23 carbon atoms and R′ is an alkyl group containing from about 1 to about 22 carbon atoms, X is a H, Na, Br, Cl, or K and ‘n’ ranges from about 2 to about 10. The alkyl groups of R and R′ may independently be saturated, unsaturated, linear, branched or a combination thereof.

### Example

The embodiments having been generally described, the following example is given as particular embodiments of the disclosure and to demonstrate the practice and advantages thereof. It is understood that the example is given by way of illustration and is not intended to limit the specification or the claims in any manner.

Two PVLC compositions, designated Lubricant Composition 1 and Lubricant Composition 2, were prepared with as a formulation of vegetable oil, surfactants, and a lime soap dispersing agent; all of the type disclosed herein. The specific formulation components are presented in Tables 1 and 2.

TABLE 1
Lubricant Composition 1

| Compound | Weight percent |
|---|---|
| Vegetable Oil | 60% to 99% |
| Lime soap dispersing agent | 0.1% to 10% |

TABLE 2
Lubricant Composition 2

| Compound | Weight percent |
|---|---|
| Vegetable Oil | 50% to 80% |
| Hydrophobic Surfactant HLB 4.3 | 1% to 5% |
| Hydrophilic Surfactant HLB 16.7 | 1% to 10% |
| Hydrophilic Surfactant HLB 15 | 1% to 10% |
| Lime soap dispersing agent | 0.1% to 10% |

Both Lubricant Composition 1 and Lubricant Composition 2 were blended at low speed (200 rpm), at ambient temperature to obtain a homogeneous finished product. Both Lubricant Composition 1 and Lubricant Composition 2 were stable after hot rolling (AHR) for 16 hours at 250° F. and 200 psi N₂ pressure, in a divalent brine (e.g., 25% CaCl₂) brine) at pH 9 or in monovalent brines such as, 10% KCl brine.

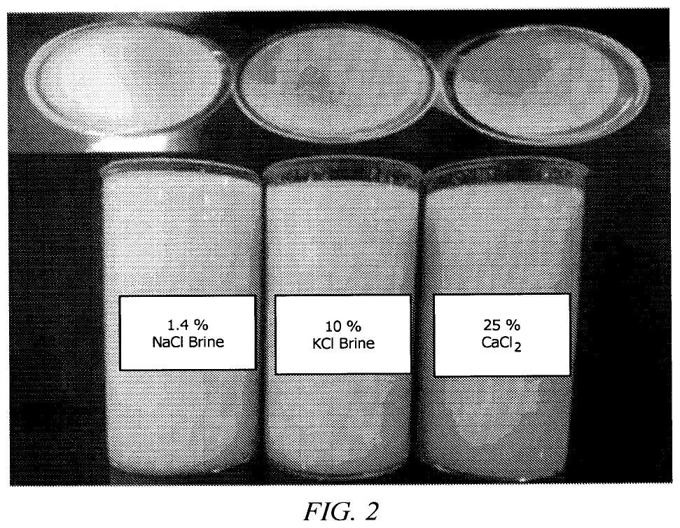

The Lubricant Compositions were first evaluated by the Cheese or Grease Test. Specifically, 2% of the lubricant composition was mixed with 1 barrel (bb1) of test brine solutions and a water-based mud (WBM) on a SILVERSON mixer for 5 minutes. The mixture was then transferred to a clean glass container and observed for any layer separation or semi solids precipitate formation or excess foaming. After 30 minutes the appearance of the mixture was observed and reported for the “cheese or grease” tendency of the lubricant. Herein cheese refers to the formation of insoluble particulates while grease refers to the formation of a separate oleaginous layer (i.e., phase separation) when the lubricant is mixed with a brine. Photographs were taken after 30 minutes post high shear mixing. These results are depicted in FIG. 2A. Samples that did not show any cheese or grease formation were then subjected to hot roll aging for sixteen hours at 250° F., under 200 psi N₂ pressure. After sixteen hours of aging, the test fluids were cooled to room temperature and mixed on a Silverson mixer for 5 minutes at 6000 rpm. The cheese and grease tendency were recorded after 30 minutes post high shear mixing. These results are depicted in FIG. 2B.

The lubricity characteristics of PVLCs of the type disclosed herein were evaluated. The lubricity of the fluids including PVLCs of the type disclosed herein were evaluated on a FALEX Lubricity meter with a Pin and Vee block and a 300 lb to 2250 lb reference load in accordance with test method. The Coefficient of Friction as a function of load using different brines and lubricant compositions are presented in FIGS. 2-5. A comparative commercially available product, was used and is herein designated the Reference Product.

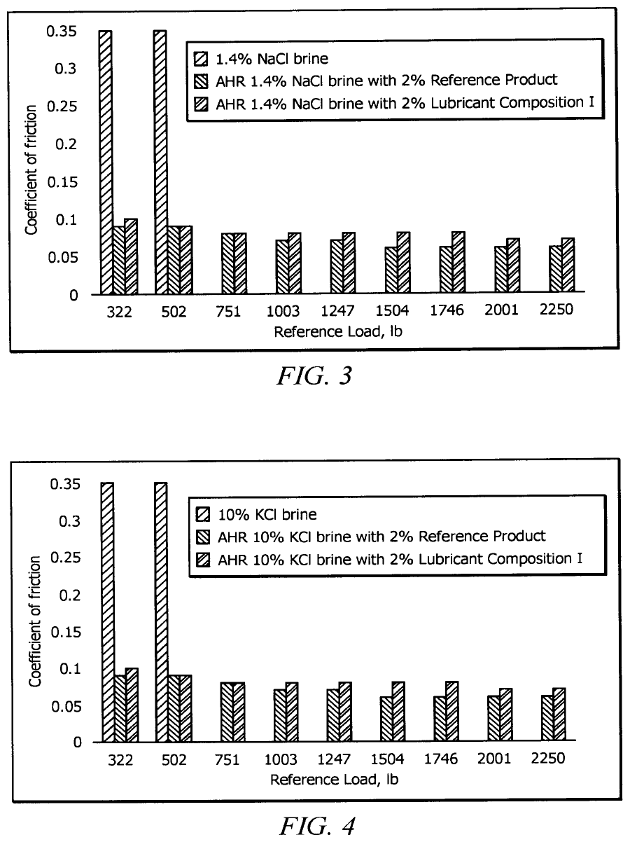

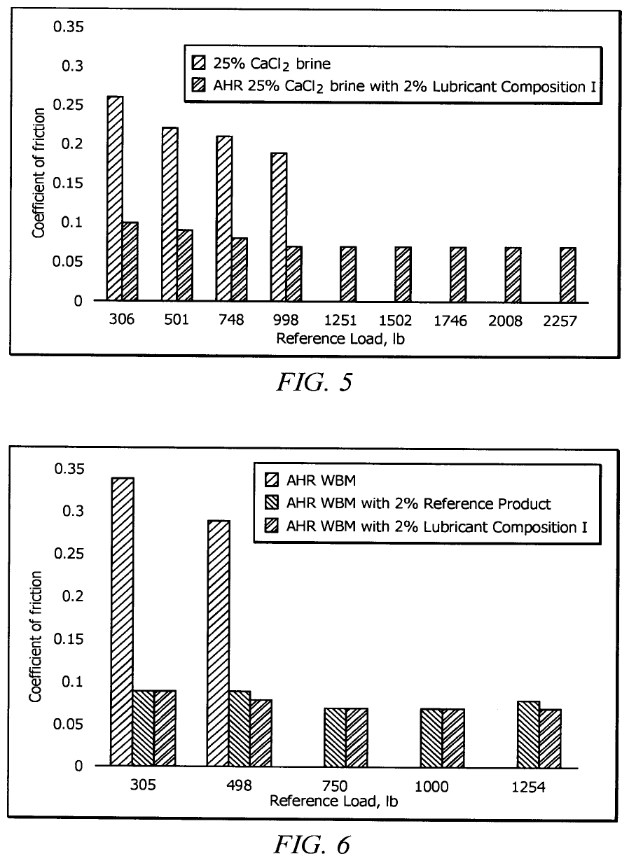

With reference to FIG. 3, in the presence of 1.4% NaCl brine and after hot rolling (AHR) samples containing either the comparative lubricant or a PVLC showed similar coefficient of frictions at the indicated loads. A similar pattern was observed in the presence of 10% KCl, FIG. 4. Notably, the comparative product is not compatible with a divalent brine. Consequently, the results provided in FIG. 5 are for the coefficient of friction for either the CaCl₂) brine alone or a mixture of a PVLC of the type described herein and a brine. The effect of a PVLC of the type disclosed herein on the coefficient of friction for a WBM containing a divalent brine is depicted in FIG. 6. The results indicate the ability of a PVLC of the type disclosed herein to reduce the coefficient of friction for monovalent or divalent brines, alone, in the presence of surfactants or as a component of a WBM.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

1. A lubricant composition, comprising:
(i) a vegetable oil; (ii) a surfactant; and (iii) a lime soap dispersing agent, wherein the lime soap dispersing agent comprises a compound having a general formula R—O—(R′O—)ₙCH₂COOX where R is an alkyl group containing from about 5 to about 23 carbon atoms and R′ is an alkyl group containing from about 1 to about 22 carbon atoms, X is a H, Na, Br, Cl, or K and ‘n’ ranges from about 2 to about 10, wherein a mixture of the lubricant composition and a brine forms less than about 1 wt. % insoluble particulates based on a total weight of the mixture, and wherein a blend comprising 2 wt. % of the lubricant composition and a CaCl₂) brine has a coefficient of friction of less than 0.1 at a reference load of from 501 g to 2257 g at room temperature.

2. The lubricant composition of claim 1, wherein the vegetable oil comprises custard seed oil, almond oil, babassu oil, castor oil, clark A oil, avocado oil, apricot oil, coffee bean oil, coconut oil, corn oil, cotton seed oil, jojoba oil, mustard seed oil, olive oil, palm oil, peanut oil, safflower oil, sesame oil, soybean oil, sunflower seed oil, wheat germ oil rapeseed oil, meadowfoam oil, lesquerella oil, borage oil, evening primrose oil, palm kernel oil, canola oil, linseed oil, rice oil, or a combination thereof.

3. The lubricant composition of claim 1, wherein the vegetable oil comprises a fatty acid comprising ricinoleic acid, oleic acid, linoleic acid, linolenic acid, stearic acid, palmitic acid, dihydroxystearic acid, octanoic acid, nonaoic acid, decanoic acid, lauric acid, myristic acid, and tricanoic acid, or any combination thereof.

4. The lubricant composition of claim 1, wherein the vegetable oil is present in an amount of from about 30 wt. % to about 90 wt. % based on a total weight of the composition.

5. The lubricant composition of claim 1, wherein the surfactant comprises a non-ionic surfactant.

6. The lubricant composition of claim 1, wherein the surfactant comprises a blend of at least two non-ionic surfactants.

7. The lubricant composition of claim 1, wherein the surfactant has a hydrophilic-lipophilic balance of from about 1 to about 10.

8. The lubricant composition of claim 1, wherein the surfactant comprises linear alcohol polyethylene oxide ethers, polyethylene glycol (PEG) esters of fatty acids, sorbitan esters, polyethoxylated sorbitan esters, sorbitan monolaurate, sorbitan monopalmitate, sorbitan monostearate, sorbitan monooleate, sorbitan sesquioleate, sorbitan trioleate, sorbitan isostearate, polyethylene glycol sorbitan monolaurate, polyethylene glycol sorbitan monopalmitate, polyethylene glycol sorbitan monostearate, polyethylene glycol sorbitan tristearate, polyethylene glycol sorbitan monooleate, or a combination thereof.

9. The lubricant composition of claim 1, wherein the surfactant is present in the lubricant composition in an amount of from about 0.5 wt. % to about 50 wt. % based on the total weight of the composition.

10. (canceled)

11. The lubricant composition of claim 1, wherein the alkyl group of R and R are each independently saturated, unsaturated, linear or branched.

12. The lubricant composition of claim 1, wherein the lime soap dispersing agent comprises one or more oleophilic fatty acid salts represented by the general formula NZ₃ wherein N is nitrogen, Z represents RCONH(CH₂)₂ and R is a C₈ to C₂₄ hydrocarbon chain.

13. The lubricant composition of claim 1, wherein the lime soap dispersing agent comprises one or more oleophilic fatty acid salts represented by the general formula NHZX where N is nitrogen, H is hydrogen, Z represents RCONH(CH₂)₂ where R is a C₈ to C₂₄ hydrocarbon chain and X is a carboxylate.

14. The lubricant composition of claim 1, wherein the lime soap dispersing agent comprises glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or a combination thereof.

15. The lubricant composition of claim 1, wherein the lime soap dispersing agent is present in an amount of from about 0.1 wt. % to about 10 wt. % based on the total weight of the composition.

16. A wellbore servicing fluid comprising:
(i) a lubricant composition comprising (a) a vegetable oil; (b) a surfactant; and (c) a lime soap dispersing agent, wherein the lime soap dispersing agent comprises a compound having a general formula R—O—(R′O—)ₙCH₂COOX where R is an alkyl group containing from about 5 to about 23 carbon atoms and R′ is an alkyl group containing from about 1 to about 22 carbon atoms, X is a H, Na, Br, Cl, or K and ‘n’ ranges from about 2 to about 10 and wherein a blend comprising 2 wt. % of the lubricant composition and a CaCl₂) brine has a coefficient of friction of less than 0.1 at a reference load of from 501 g to 2257 g at room temperature; and
(ii) a drilling mud comprising a base fluid wherein the base fluid comprises a brine.

17. The wellbore servicing fluid of claim 16, wherein the vegetable oil comprises custard seed oil, almond oil, babassu oil, castor oil, clark A oil, avocado oil, apricot oil, coffee bean oil, coconut oil, corn oil, cotton seed oil, jojoba oil, mustard seed oil, olive oil, palm oil, peanut oil, safflower oil, sesame oil, soybean oil, sunflower seed oil, wheat germ oil rapeseed oil.

18. The wellbore servicing fluid of claim 16, wherein the lime soap dispersing agent comprises glycolic acid ethoxylate lauryl ether, glycolic acid ethoxylate oleyl ether, ethoxylated poly(ethylene glycol) acid, ethoxylated carboxylic acid and ethoxylated carboxylic acid anhydrides, ethoxylated glucuronic acid derivatives thereof or a combination thereof.

19. A method of servicing a wellbore comprising;
placing into a wellbore disposed in a subterranean formation a wellbore servicing fluid comprising
(i) a lubricant composition comprising (a) a vegetable oil; (b) a surfactant; and (c) a lime soap dispersing agent;
(ii) a base fluid; and
(iii) a brine.

20. The method of claim 19, wherein the vegetable oil comprises castor oil; the surfactant comprises a non-ionic surfactant and the lime soap dispersing agent comprises may be characterized by the general formula R—O—(R′O—)ₙCH₂COOX where R is an alkyl group containing from about 5 to about 23 carbon atoms and R′ is an alkyl group containing from about 1

21. The wellbore servicing fluid of claim 16, wherein the wellbore servicing fluid has a density of from about 9 lbs/gal to about 12.5 lbs/gal.
